(19) United States
(12) Patent Application Publication
(10) Pub. No.: US 2026/0209585 A1
(43) Pub. Date: Jul. 23, 2026

(54) FINISH POLISHING COMPOSITION

(71) Applicant: ANJI MICROELECTRONICS TECHNOLOGY (SHANGHAI) CO., LTD., Pudong New Area, Shanghai (CN)

(72) Inventors: Pengyu XU, Shanghai (CN); Yinbin CHEN, Shanghai (CN); Nan JIANG, Shanghai (CN); Xingping WANG, Shanghai (CN); Zhangzheng JIA, Shanghai (CN); Shoutian LI, Shanghai (CN)

(21) Appl. No.: 19/138,014

(22) PCT Filed: Dec. 12, 2023
(86) PCT No.: PCT/CN2023/138007

§ 371 Date: Jun. 11, 2025

(30) Foreign Application Priority Data
Dec. 13, 2022 (CN) 202211595637.0

(51) Int. Cl. C09K 3/14

(52) U.S. Cl. CPC C09K 3/1463

(57) ABSTRACT

The invention provides a light wiping and polishing composition comprising cerium oxide abrasive particles, an anionic polymer, a cationic polymer, a nitrogen-containing heterocyclic carboxylic acid, and a nonionic surfactant. The present invention provides polishing compositions that use a polishing liquid component for silicon oxide light rubs that is nearly free of abrasive particles, the light rub polishing composition is capable of removing the silicon oxide dielectric layer (e.g., the polishing rate is greater than 300 Å/min when the solid content is lower than 50 ppm), stopping on tungsten, silicon nitride, or polysilicon (polishing rates less than 50 Å/min, alternatively less than 20 Å/min, alternatively less than 10 Å/min).

### TECHNICAL FIELD

The present invention relates to the field of chemical mechanical polishing (CMP) and particularly pertains to a polishing composition.

### BACKGROUND

Light wiping polishing solutions are typically employed for post-primary polishing repair processes, such as removing a controlled amount of silicon oxide dielectric layer to improve surface topography of patterned product wafers, addressing defects including erosion or dishing, or rectifying surface imperfections induced by polishing. The light wiping polishing process is generally applied following tungsten (W), barrier layer, silicon nitride stop layer, or polysilicon stop layer CMP procedures. This technique achieves a silicon oxide dielectric removal rate of 200-300 Å/min, while exhibiting negligible polishing rates (<1 Å/min) on stop-layer materials.

In conventional techniques, standard light wiping polishing processes predominantly utilize nano-sized silicon oxide (SiO₂) as abrasive particles, with abrasive concentrations typically exceeding 1% by weight (wt %). When the abrasive concentration falls below 1 wt %, the polishing rate for silicon oxide dielectric layers often becomes insufficient. The use of high solid-load abrasive systems primarily introduces three critical challenges:
(1) Scratch Defects. Scratch formation originates from oversized abrasive agglomerates within polishing particles. Elevated solid content amplifies the population of these defect-inducing large particles, thereby increasing scratch probability. For instance, the published study “Analysis of Large Particle Count in Fumed Silica Slurries and Its Correlation with Scratch Defects Generated by CMP” by E. Remsen etc in Journal of The Electrochemical Society, 153 (5), G453-G461 (2006) demonstrates a direct correlation between oversized particle concentration (>200 nm) and scratch defect density.
(2) Post-CMP Cleaning. Following chemical mechanical polishing (CMP), a significant quantity of abrasive particles remains adhered to the wafer surface. Higher solid content in polishing slurries directly correlates with increased residual particle counts. These contaminants must be thoroughly removed, with stringent residual limits such as <100 particles (>0.2 μm) per wafer as measured by laser scattering defect inspection tool. Cleaning processes face heightened complexity, particularly for cerium oxide (CeO₂) particles, where high solid-load slurries exacerbate removal challenges.
(3) Cost. The abrasive particles in CMP slurries constitute the predominant cost component, typically accounting for 90-99% of total slurry production costs.

The above three issues can all be addressed by reducing the solid content. When the solid content is extremely low, the number of large particles decreases sharply, reducing the possibility of scratches; due to the very low number of particles, the cleaning burden becomes smaller; and at the same time, it can significantly reduce the cost.

To reduce the solid content, the existing technology has introduced “abrasive-free” polishing solutions for copper interconnects. For example, the patent: U.S. Pat. No. 6,117,775. However, strictly speaking, the so-called “abrasive-free” does not mean there are absolutely no abrasive particles, but rather the content of abrasive particles is extremely low, such as close to 0.0001%, close to 0.001%, or close to 0.01%. In the formulation of copper polishing solutions, achieving “abrasive-free” is relatively easy because the polishing mechanism of copper is realized through the following steps: (1) oxidants such as peroxides oxidize metallic copper to copper oxide; (2) complexing agents convert copper oxide into water-soluble copper complexes; (3) copper inhibitors form an insoluble protective film on the copper surface; (4) polishing pads, the mechanical action of abrasive particles, push aside the protective film, allowing the complexing agent to dissolve copper oxide and bring it into the solution; (5) repeat steps 1-4.

For silicon polished oxide dielectric materials, “no abrasive particles” are difficult to achieve the same level of effect as copper polishing solutions because there is no complexing agent for silicon oxide. Using silica as a polishing liquid for abrasive particles, the polishing rate and solid content are closely related, and when the solid content is below 1%, the polishing rate is close to zero.

Thus, silica polishing compositions including low solids content have not been disclosed in prior art.

### DESCRIPTION

To solve the above technical problems, a light wiping and polishing composition suitable for polishing silicon oxide is provided, which effectively reduces the surface morphology and polishing effect of the wafer after polishing. The present invention provides a light wiping and polishing composition, which comprises: cerium oxide abrasive particles, an anionic polymer, a cationic polymer, a nitrogen-containing heterocyclic carboxylic acid, and a nonionic surfactant.

Preferably, the cerium oxide abrasive particles are colloidal cerium oxide particles.

Preferably, the cerium oxide abrasive particles are present in an amount of less than 0.1 wt %.

Preferably, the cerium oxide abrasive particles are present in an amount of less than 0.01 wt %.

Preferably, the anionic polymer is selected from phosphate anion polymers or carboxylic acid anion polymers.

Preferably, the phosphate group is selected from one or more of phosphoric acid, potassium phosphate, dihydrogen phosphate potassium, and Amino Trimethylene Phosphonic Acid (ATMP).

Preferably, the anionic polymer is polyacrylic ammonium salt and copolymers thereof.

Preferably, the cationic polymer is polyquaternium.

Preferably, the cationic polymer is selected from one or more of Polyquaternium 2, Polyquaternium 6, Polyquaternium 7, Polyquaternium 28, Polyquaternium 37.

Preferably, the nitrogen-containing heterocyclic carboxylic acid is pyridine carboxylic acid.

Preferably, the non-ionic surfactant is polyethylene glycol.

Preferably, the pH of the polishing composition is less than 8.

The present invention provides a polishing composition, using a polishing liquid component for light polishing of silicon oxide with almost no abrasive particles. This component contains abrasive particles with a shell-core structure, with a content of only a few tens of ppm (one part per million), having a positive charge on the surface, and a pH value in the range of weak acidity (pH 3-7). The abrasive particles with a shell-core structure contain cerium oxide particles as the core, and a specially formed organic polymer double-layer shell. The light wiping and polishing liquid can remove the silicon oxide dielectric layer (for example, the polishing rate is greater than 300 Å/min when the solid content is lower than 50 ppm), and stops on tungsten, silicon nitride or polycrystalline silicon (the polishing rate is less than 50 Å/min, or less than 20 Å/min, or less than 10 Å/min).

The grinding particles of the shell structure are achieved through a two-step process: (1) Let the polymer containing anionic functional groups wrap the surface of cerium oxide particles with positive charges through electrostatic or complexation methods; the anionic polymer contains oxygen-containing complexing functional groups and can be adsorbed on the surface of cerium oxide through complexation or positive-negative charge attraction methods. (2) Based on the first step, the polymers containing cationic functional groups are adsorbed onto the first layer through the attraction of positive and negative charges or the van der Waals forces between the carbon-hydrogen bonds of the polymer main chain, thereby forming a multi-shell polymer layer. This double-layer structure coats a soft organic layer on the surface of cerium oxide, reducing the impact force on the oxide silicon dielectric layer during polishing. It also reduces the formation of difficult-to-clean Ce-O-Si bonds between cerium oxide and oxide silicon surfaces, minimizing scratches and reducing the possibility of cerium oxide adsorbing on the wafer surface. It should be noted that the adsorption of cerium oxide on the oxide silicon wafer surface will also prevent subsequent cerium oxide particles from polishing the oxide silicon, thereby reducing the polishing rate.

### EMBODIMENTS

The advantages of the invention will be further explained in detail with reference to the following embodiments.

### Embodiment 1

After mixing 1 kg of cerium oxide particles, 40 g of the ammonium polyacrylate salt, and 8740 g of deionized water, dispersion was carried out with stirring and sonication for 30 minutes. Subsequently 220 g of Polyquaternium 7 was added, followed by dilution to 0.002% cerium oxide content, followed by addition of 100 ppm picolinic acid, 100 ppm polyethylene glycol (molecular weight 10,000) and the pH was adjusted to 4.8 using nitric acid.

### Embodiment 2

After mixing 1 kg of cerium oxide particles, 40 g of the ammonium polyacrylate salt, and 8740 g of deionized water, dispersion was carried out with stirring and sonication for 30 minutes. Subsequently 220 g of Polyquaternium 7 was added, followed by dilution to 0.005% cerium oxide content, followed by addition of 100 ppm picolinic acid, 100 ppm polyethylene glycol (molecular weight 10,000) and the pH was adjusted to 4.8 using nitric acid.

### Embodiment 3

After mixing 1 kg of cerium oxide particles, 60 g of dipotassium phosphate and 8720 g of deionized water, the dispersion was carried out with stirring and sonication for 30 minutes. Subsequently 220 g of Polyquaternium 7 was added, followed by dilution to 0.002% cerium oxide content, followed by addition of 100 ppm picolinic acid, 100 ppm polyethylene glycol (molecular weight 10,000) and the pH was adjusted to 4.8 using nitric acid.

### Embodiment 4

After mixing 1 kg of cerium oxide particles, 40 g of the ammonium polyacrylate salt, and 8740 g of deionized water, dispersion was carried out with stirring and sonication for 30 minutes. Subsequently 220 g of Polyquaternium 37 was added, followed by dilution to 0.1% cerium oxide content, followed by addition of 100 ppm picolinic acid, 100 ppm polyethylene glycol (molecular weight 10,000) and pH was adjusted to 4.8 using nitric acid.

### Comparative Embodiment 1

Dilute 1 kg of water-based silica slurry to a silica content of 0.002%.

### Comparative Embodiment 2

Dilute 1 kg of water-based silica slurry to a silica content of 0.1%.

### Comparative Embodiment 3

After mixing 1 kg of cerium oxide particles, 40 g of the ammonium polyacrylate salt, and 8740 g of deionized water, dispersion was carried out with stirring and sonication for 30 minutes. Followed by addition of 220 g of Polyquaternium 7, followed by dilution to 0.1% cerium oxide content, followed by addition of 100 ppm picolinic acid, 100 ppm polyethylene glycol (molecular weight 10,000), pH adjusted to 8 using nitric acid.

Polishing object: TEOS blank wafers and patterned wafers (with TEOS films deposited with different line/slot structures), the measured line width/slot width of the patterned TEOS is 100 μm/100 μm.

Polishing equipment: Mirra polishing machine; IC1010 polishing pad; NanoSpec film thickness measurement system (NanoSpec6100-300, Shanghai Nanospec Technology Corporation).

Polishing conditions: The spindle speeds of Platten and Carrier are 93 rpm and 87 rpm respectively, the polishing pressure is 2.0 psi, and the flow rate of the polishing solution is 150 mL/min.

Polishing Step: The TEOS blank wafer and graphic wafer were subjected to a polishing process using the above prepared polishing solution using the above-described polishing apparatus and polishing conditions, respectively. Starting at 3 mm from the wafer edge, 49 points were measured at equal spacing on the diameter line and their polishing rates were tested separately, thus, the polishing rate for each polishing liquid was an average of the polishing rates over 49 points. The polishing results were measured as shown in Table 1.

TABLE 1
Components and Content of Embodiments 1-4 and Comparative
Embodiments 1-3, and Polishing Test Results

| | | | | | | RR- | RR- | RR- | RR- |
|---|---|---|---|---|---|---|---|---|---|
| | | | Solid | Additive | Additive | SiO2 | SiN | Poly | W |
| | Anion | Cation | content | 1 | 2 | (Å/min) | (Å/min) | (Å/min) | (Å/min) |
| Embodiment | 0.08 | 0.44 | 0.002 | 100 | 100 | 755 | 13 | 0 | 11 |
| 1 | ppm | ppm | wt % | ppm | ppm | | | | |
| Embodiment | 0.08 | 0.44 | 0.005 | 100 | 100 | 1264 | 6 | 0 | 8 |
| 2 | ppm | ppm | wt % | ppm | ppm | | | | |
| Embodiment | 0.12 | 0.44 | 0.002 | 100 | 100 | 730 | 9 | 22 | 0 |
| 3 | ppm | ppm | wt % | ppm | ppm | | | | |
| Embodiment | 0.08 | 0.44 | 0.002 | 100 | 100 | 966 | 2 | 7 | 1 |
| 4 | ppm | ppm | wt % | ppm | ppm | | | | |
| Comparative | | | 0.002 | 100 | 100 | 3 | 1 | 0 | 10 |
| Embodiment | | | wt % | ppm | ppm | | | | |
| 1 | | | | | | | | | |
| Comparative | | | 0.1 | 100 | 100 | 0 | 0 | 413 | 5 |
| Embodiment | | | wt % | ppm | ppm | | | | |
| 2 | | | | | | | | | |
| Comparative | 0.08 | 0.44 | 0.002 | 100 | 100 | 559 | 108 | 9 | 4 |
| Embodiment | ppm | ppm | wt % | ppm | ppm | | | | |
| 3 | | | | | | | | | |

As can be seen from Table 1, Embodiments 1~4 show that after adding the corresponding anionic and cationic surfactants, sufficient polishing rate can still be maintained. The added pyridine acid and polyethylene glycol can effectively inhibit silicon nitride, polycrystalline silicon, and tungsten. This can meet the requirements of a light abrasive polishing solution as a dielectric layer, while ensuring its extremely low solid content. This can minimize the scratches generated during the polishing process. Comparative Embodiments 1 and 2 are obtained by diluting the currently popular silicon oxide polishing solution. When diluted to the same solid content as the current examples, it can be seen that the silicon oxide has almost no polishing speed, so it cannot meet our usage requirements and cannot meet our requirements for cost reduction and scratch prevention. Comparative Embodiment 3 indicates that when the pH value of the polishing solution is higher than 8, it cannot effectively protect the silicon nitride film. Therefore, we need to select a pH less than 8.

In summary, by using the anionic molecules and the insulating film polishing promoter as defined in the present invention, along with pyridine formate and polyethylene glycol, the polishing rate can be effectively increased even under extremely low solid content conditions, while ensuring the polishing rate of silicon oxide, stopping at tungsten, silicon nitride or silicon, potentially polycrystalline and significantly reducing the scratches generated during the polishing process, thereby greatly improving the yield of the product.

Although the above specific embodiments of the present invention have been described in detail, they are only Embodiments, and the present disclosure is limited to the embodiments described above. For those skilled in the art, any equivalent modification and substitution to the present invention is also covered in the present invention. Therefore, all these equivalent changes and modifications made without departing from the spirit and scope of the invention should be covered within the scope of the present invention.

1. A light wiping and polishing composition comprising: cerium oxide abrasive particles, an anionic polymer, a cationic polymer, a nitrogen-containing heterocyclic carboxylic acid, and a nonionic surfactant.

2. The light wiping and polishing composition according to claim 1, wherein, the cerium oxide abrasive particles are colloidal cerium oxide particles.

3. The light wiping and polishing composition according to claim 1, wherein, the cerium oxide abrasive particles are present in an amount of less than 0.1 wt %.

4. The light wiping and polishing composition according to claim 3, wherein, the cerium oxide abrasive particles are present in an amount of less than 0.01 wt %.

5. The light wiping and polishing composition according to claim 1, wherein the anionic polymer is selected from phosphate anion polymers or carboxylic acid anion polymers.

6. The light wiping and polishing composition according to claim 5, wherein the phosphate group is selected from one or more of phosphoric acid, potassium phosphate, dihydrogen phosphate potassium, and Amino Trimethylene Phosphonic Acid (ATMP).

7. The light wiping and polishing composition according to claim 6, wherein the anionic polymer is polyacrylic ammonium salt and copolymers thereof.

8. The light wiping and polishing composition according to claim 1, wherein the cationic polymer is polyquaternium.

9. The light wiping and polishing composition according to claim 1, wherein the cationic polymer is selected from one or more of Polyquaternium 2, Polyquaternium 6, Polyquaternium 7, Polyquaternium 28, Polyquaternium 37.

10. The light wiping and polishing composition according to claim 1, wherein the nitrogen-containing heterocyclic carboxylic acid is pyridine carboxylic acid.

11. The light wiping and polishing composition according to claim 1, wherein the non-ionic surfactant is polyethylene glycol.

12. The light wiping and polishing composition according to claim 1, wherein the pH of the polishing composition is less than 8.
